(19) United States
(12) Patent Application Publication
(10) Pub. No.: US 2007/0043821 A1
(43) Pub. Date: Feb. 22, 2007

(54) Method and system for task delegation via instant message

(76) Inventor: Sara Carlstead Brumfield, Austin, TX (US)

Correspondence Address: IBM CORP (YA);C/O YEE & ASSOCIATES PC, P.O. BOX 802333, DALLAS, TX, 75380, US

(21) Appl. No.: 11/207,076

(22) Filed: Aug. 18, 2005

(51) Int. Cl. G06F 15/16

(52) U.S. Cl. 709/207

(57) ABSTRACT

A system for the quick and efficient delegation of a task via an instant messaging system. A task leader sends an instant message broadcast to members in a workgroup. Each responding workgroup member is listed with biographical information on a result screen. The task is delegated to one or more of the responding workgroup members. Subsequently, the delegated task and the responding workgroup members to whom the task was delegated are stored and tracked.

### BACKGROUND OF THE INVENTION

1. Technical Field of the Invention

The present invention relates generally to an improved data processing system. More specifically, the present invention is directed to a method, apparatus, and computer instructions for processing and displaying messages. Still more specifically, the present invention provides a method, apparatus, and computer program product for the efficient delegation of tasks among team members via instant messaging in an instant messaging system.

2. Description of the Related Art

There is no doubt that the Internet has changed the way people and businesses communicate. For many people and institutions, e-mail has virtually replaced traditional letters and even telephone calls as the preferred choice of correspondence. Every day, billions of e-mail messages are sent on the Internet. E-mail has been the most rapidly adopted form of communication ever known. In less than two decades, it has gone from obscurity to mainstream dominance.

In the fast-paced world of today, sometimes even the rapid response of e-mail is not fast enough. Currently, there is no way of knowing if the person you are sending an e-mail to is online at that particular moment or not. Also, if multiple e-mails are sent back and forth with the same person, normally the e-mail recipient has to click through a few steps to read, reply, and send an e-mail back to the sender. For that reason, instant messaging (IM) has gained popularity.

Instant messaging is a type of computer application that is designed to facilitate communication among multiple computer users attached to a network, such as, for example, the Internet. Instant messaging may be implemented in various ways, but in general it supports the sending and receiving of instant messages to and from other users. Instant messages are correspondence that appears on a computer display of a recipient more or less instantly after being sent. This is opposed to the more traditional e-mail messages, which typically are logged in the system until a recipient wishes to view them. The ability to receive correspondence instantly gives instant messaging a more spontaneous, conversational quality to it than does traditional e-mail. Thus, instant messaging provides an alternative form of communication using computers attached to a network. Instant message applications may be used by a variety of users, such as, groups of individuals working closely together on some critical project or more casual users at home wanting to see if someone is available to receive a message immediately.

Instant messaging allows a person or business to maintain a list of people that they desire to interact with. The person or business may send messages to any of the individuals contained on the list, often called a buddy list or contact list, as long as the individual is online at the time the message is sent. Sending an instant message opens up a small window display on each computer interface so that both individuals involved with in the process may type in and read messages.

Normally, instant messaging involves two people online, sending notes back and forth to each other. A “chat room” is a software program that allows a group of people to communicate with each other by allowing each member of the group to type in messages that are seen by everyone in the chat room. An instant messaging system generally comprises a plurality of instant messaging client devices coupled to an instant messaging server via a data processing system network. Messages and connection information is maintained on the server that is controlled by a provider of the instant messaging service. Examples of instant messaging services are America Online Instant Messenger (AIM), Microsoft Network (MSN) Messenger, and Yahoo! Messenger.

Today, most computers are connected to some type of network. A network allows a computer to share information with other computer systems. The Internet is only one example of a computer network. Many commercial business environments connect computers via a local area network (LAN) or by another means. A LAN may be utilized by a business enterprise to connect its computers for the purpose of allowing co-workers to effectively communicate with each other. In most business environments, effective communication between employees is essential to increased productivity.

Increased productivity includes the effective communication of task delegation and assignment by a facilitator in the enterprise. A facilitator may be a manager, team leader, or teammate for the workgroup assigned the task by the enterprise. Currently, the facilitator has the option to personally meet with each individual in the workgroup, telephone each workgroup member, e-mail everyone involved, schedule a group meeting, or use instant messaging to contact members of the workgroup individually or as a group.

In the case of meeting individually with or telephoning each member of the workgroup, the facilitator guesses who is currently available and wastes valuable time using this hit or miss technique. In the case of e-mail, sending the message to all members of the workgroup at the same time may be fast and efficient, however, the response by the workgroup members may be slow because members have the option to read and respond to the e-mail at their leisure. In the case of scheduling a group meeting, delay is expected because of waiting for a time when all can attend. Also, workgroup productivity is decreased by having the workgroup attend a meeting instead of continuing to work. Instant messaging provides the most efficient means of communication between the facilitator and workgroup members because members of the workgroup do not have to leave their workstation and communication is instantaneous. However, while instant messaging systems provide for individual or group discussions, presently there is no instant messaging system that provides for the effective dispatch of work tasks among members of a workgroup.

Therefore, it would be advantageous to have a method, apparatus, and computer program product for the efficient delegation of work tasks by a team leader to workgroup members via instant messaging.

### SUMMARY OF THE INVENTION

The present invention provides a method, apparatus, and computer program product for quickly and efficiently delegating a task by utilizing an instant messaging system. A task leader sends an instant task delegation message broadcast to members in a workgroup and receives one or more responses to the task delegation message from the workgroup members. Each responding workgroup member is listed with the responding workgroup member's biographical information on a result screen. Subsequently, the task is delegated to at least one of the responding workgroup members. The delegated task and the responding workgroup members to whom the task was assigned are stored and then tracked.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a block diagram illustrating components used in managing messages in accordance with a preferred embodiment of the present invention;

FIG. 5 is a diagram illustrating an instant messaging client in accordance with a preferred embodiment of the present invention;

FIG. 6 is an example display illustrating a leader task initiation page in accordance with a preferred embodiment of the present invention;

FIG. 7 is an example display illustrating a workgroup task response page in accordance with a preferred embodiment of the present invention;

FIG. 8 is an example display illustrating a result screen that lists task respondents in accordance with a preferred embodiment of the present invention;

FIG. 9 is a flowchart of a process for using a workgroup leader instant messaging device in accordance with a preferred embodiment of the present invention; and

FIG. 10 is a flowchart of a process for utilizing a workgroup member instant messaging device in accordance with a preferred embodiment of the present invention.

### DETAILED DESCRIPTION OF THE PREFERRED EMBODIMENT

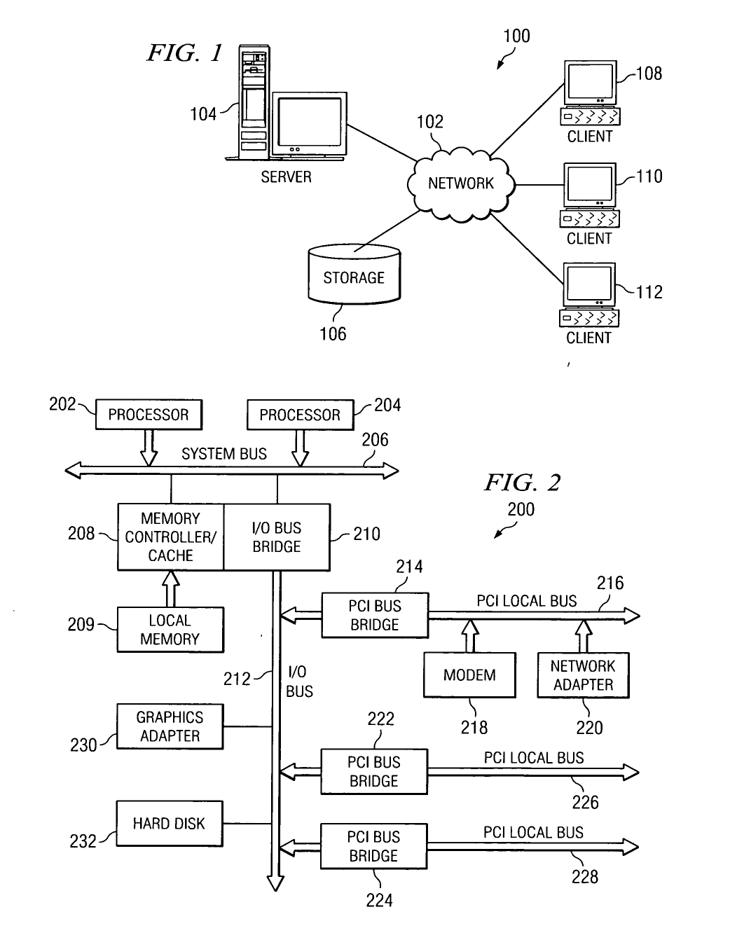

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers or personal digital assistants (PDAs). In the depicted example, server 104 provides data, such as boot files, operating system images, and applications to clients 108-112. Clients 108, 110, and 112 are clients to server 104. Server 104 may act as an instant messaging server to facilitate the exchange of messages between users at clients, such as clients 108, 110, and 112. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

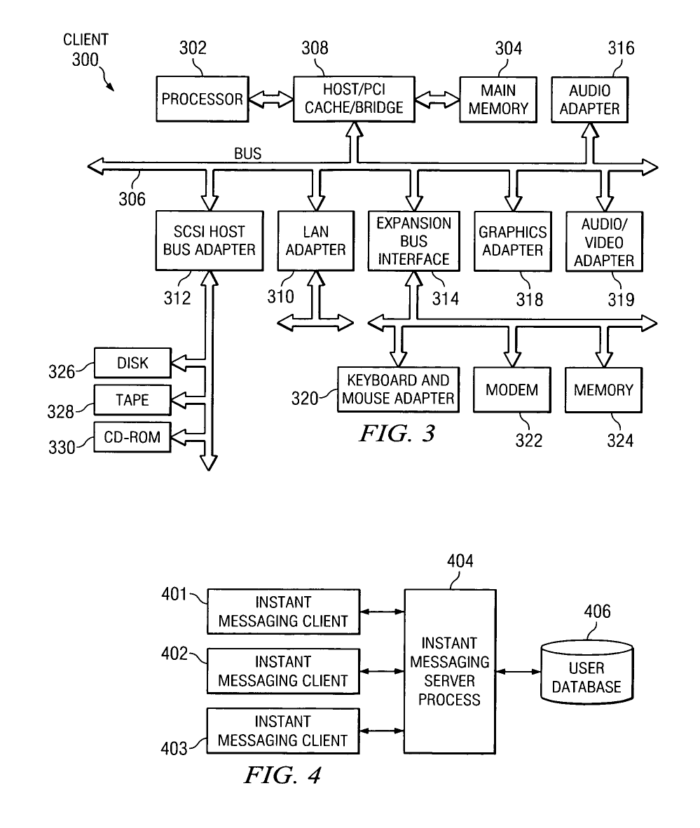

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention provides a method, apparatus, and computer instructions for fast task delegation by employing an instant messaging system. The process begins when a task leader sends an instant message broadcast for the purpose of delegating a task to members in a workgroup. Each responding workgroup member to the task delegation message is listed on a result screen with the biographical information of each responding workgroup member. Subsequently, the task leader delegates or assigns the task to one or more of the responding workgroup members. Alternatively, if the task leader sets a response preference on the leader task initiation page, the task may be automatically delegated to the first responding workgroup member. Another automatic delegation alternative may be to select a workgroup member on a best match basis using the biographical information provided on the result screen.

Subsequent to each task being delegated, each task is then tracked. Each delegated task may be tracked by storing task information, which includes the workgroup member assigned to the task, in a task delegation database. After the task information is stored, the instant messaging system may integrate and reference the stored information in the task delegation database to allow for determining which tasks have been delegated and to whom.

An advantage of the present invention is that task delegation time is greatly reduced by not requiring a task leader to schedule a workgroup meeting to discuss the task and its subsequent delegation to a member of the workgroup. In fact, no discussion is required between the task leader and the workgroup because the task description is provided in the initial task delegation broadcast message. Therefore, the task delegation message may be sent out by the task leader almost immediately upon receipt to workgroup members. In response, workgroup members merely need to indicate on a response page whether they are available to perform the task. Thus, the present invention provides a system for almost instantaneous task delegation, with real time feedback and agreement from workgroup members. In addition, the present invention provides a system where workgroup members have an option to accept the task assignment.

Another advantage of the present invention is that a brief biographical sketch is provided with the respective name of each responsive workgroup member that indicated that he or she is available for the task assignment. This feature quickly provides the task leader with valuable information, assisting the task leader in selecting the best workgroup member for the task. Alternatively, embodiments of the present invention may be programmed to automatically select a best match using the biographical information of each responding workgroup member. Also, the task leader can quickly see on a result screen who is and who is not available for task delegation, and why.

Turning now to FIG. 4, a block diagram illustrating components used in an instant messaging system in accordance with a preferred embodiment of the present invention is shown. In this illustrative example, a user at instant messaging client 401 may send or exchange messages with other users at instant messaging clients 402 and 403. The sending of messages may be via instant and broadcast messaging.

Broadcast messaging provides a means for sending a single message instantly to all members of a predefined community of instant messaging clients. Broadcast messaging may be utilized within the predefined community to, for example, conduct instant, just-in-time chat rooms, broadcast instant alert messages, instantly broadcast a need for skills and receive an immediate reply, hold instant web presentations, and poll individuals within the predefined community for instant feedback. The predefined community may be, for example, all employees of a business or enterprise, members of an organization or club, students, teachers, and support staff of an educational institution, consumers of a particular product, governmental entities, and individuals, all of which may comprise a contact or buddy list individually or in combination.

Instant messaging clients 401, 402, and 403 may be executing on a data processing system, such as, for example, data processing system 300 in FIG. 3. It should be noted that even though the example illustration of FIG. 4 depicts three instant messaging clients, the present invention is not restricted to such. For example, an entity using the method and system of the present invention may employ fewer or more instant messaging clients as is necessary to complete the mission of the entity. The exchange of messages in these examples is facilitated through instant messaging server process 404. This process allows users to find other users within the instant messaging system, as well as, aid in the exchange of messages between different users.

Depending on the particular instant messaging system, instant messaging server process 404 may only be involved in providing an indication of when particular users are online and for establishing initial contacts while users contacting users already on a buddy list may contact those users directly after seeing that a particular user is online. Instant messaging server process 404 may be located on a server, such as data processing system 200 in FIG. 2.

In these examples, the different users registered to the instant messaging system are stored in user database 406. This user database provides information needed to search for and find other users, as well as, contact users when they are online.

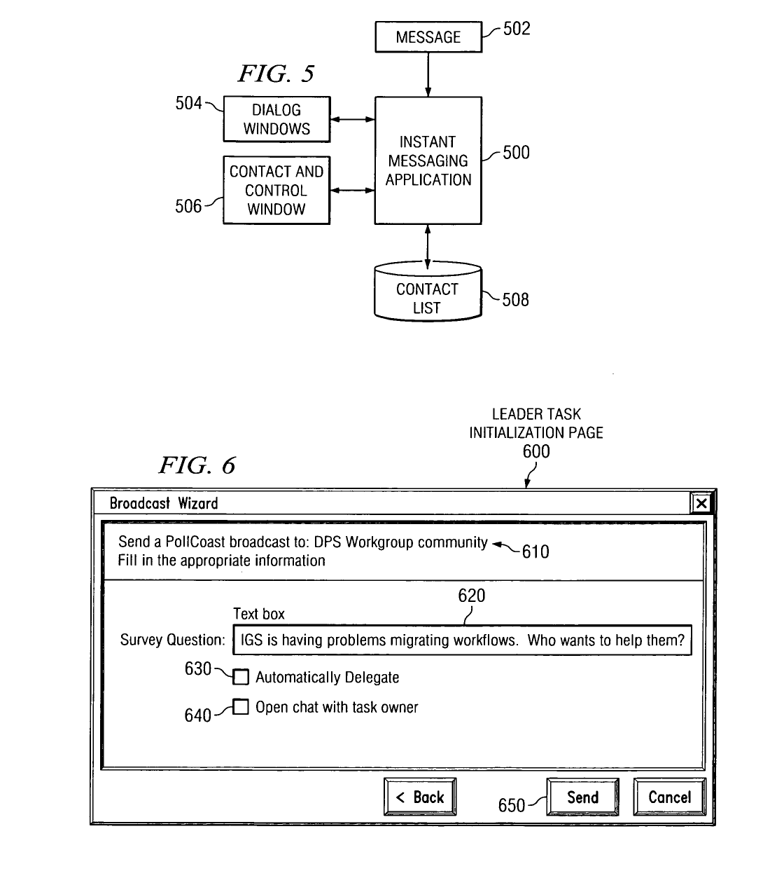

Turning next to FIG. 5, a diagram illustrating an instant messaging client is depicted in accordance with a preferred embodiment of the present invention. The components illustrated in FIG. 5 may be found in an instant messaging client, such as instant messaging clients 401, 402, and 403 in FIG. 4. These components may be implemented in a data processing system, such as, for example, data processing system 300 in FIG. 3.

In the illustrative example, instant messaging application 500 processes messages, such as, for example, message 502. As messages are received, these messages are presented in dialog windows 504. Additionally, dialog windows 504 provide an interface for a user to input text to send messages to other users.

Contact and control window 506 is presented by instant messaging application 500 to provide the user with a list of user names, as well as other information. Contact and control window 506 also provides an interface to allow a user to set different preferences. For example, the user may set passwords required to access different names used in instant messaging sessions.

Also, a user may employ contact and control window 506 to set other preferences, such as colors and fonts used in instant messaging application 500. These preferences also may include whether a picture is to be sent when a session is initiated with another user. Depending on the implementation, the preference may be set to allow a user who receives messages to retrieve images of the senders from a remote database or a local cache.

Further, a list of names presented by contact and control window 506 is stored in contact list 508 in these examples. Additional user or screen names may be added to or deleted from contact list 508. Contact list 508 is employed in presenting the list of names within contact and control window 506.

With reference now to FIG. 6, an example display illustrating a leader task initiation page is shown in accordance with a preferred embodiment of the present invention. Leader task initiation page 600 is utilized by a task leader to initiate delegation of a task to a specified or predetermined workgroup, such as workgroup community 610. Leader task initiation page 600 may be, for example, provided by instant messaging application 500 and displayed in dialog windows 504 in FIG. 5.

The task leader may input the desired task delegation information in leader task initiation page 600 by using, for example, contact and control window 506 in FIG. 5. Specified or predefined workgroup community 610 may be selected from a contact list, such as, for example, contact list 508 in FIG. 5. Workgroup community 610 may be determined by the task leader selecting individual names contained in the contact list, by selecting a predetermined workgroup from among a list of workgroups, where each workgroup comprises a two or more individuals, or by the task leader selecting any combination thereof.

After determining workgroup community 610, the task leader inputs the task, which is to be delegated to a member of workgroup community 610, into text box 620. The text describing the task may be a message, such as, for example, message 502 in FIG. 5. Text box 620 may be a single line as shown in the exemplary illustration of FIG. 6 or may be an expanding text box up to a predetermined word limit.

In addition to inputting the task into text box 620, the task leader may select task delegation response preferences 630 and 640. Task delegation response preferences 630 and 640 may include items, such as, for example, automatic delegation of a task and automatic opening of dialog or chat windows between a task leader and a task owner after task delegation, respectively. Automatic delegation preference 630 may be used to delegate the task, for example, to a first responding workgroup member. Alternatively, automatic delegation preference 630 may be used to delegate the task, for example, to a best match using biographical information of each responding workgroup member.

However, the present invention is not limited to the immediately preceding list of task delegation response preferences. Any task delegation response preference necessary to insure that the task is delegated efficiently and effectively may be incorporated into leader task initiation page 600 as required. Further, it should be noted that leader task initiation page 600 may include any information or content, such as, for example, pictures, diagrams, flowcharts, and the like, for proper task delegation.

Subsequent to the completion of leader task initiation page 600, the task leader “hits” send button 650 to broadcast the task delegation message to workgroup community 610. For example, a user of instant message client 401 broadcasts a message to instant messaging clients 402 and 403 via instant messaging server process 404 in FIG. 4.

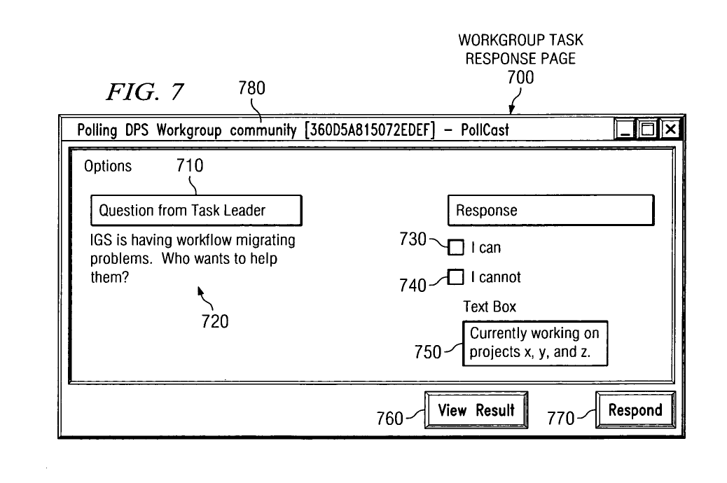

Referring now to FIG. 7, an example display illustrating a workgroup task response page is depicted in accordance with a preferred embodiment of the present invention. Workgroup task response page 700 is employed to disseminate task description 720 to workgroup community 780 from task leader 710. For example, the task description input of text box 620 on leader task initiation page 600 is sent to workgroup community 610 in FIG. 6. Each member of workgroup community 780 that is logged-on to an instant messaging program, such as, for example, instant messaging application 500 in FIG. 5, receives a copy of workgroup task response page 700. Workgroup response page 700 appears in a display window, such as, dialog window 504 in FIG. 5, on a client device, such as, instant messaging client 401 in FIG. 4, for each member of workgroup community 780. Each member of workgroup community 780 that is logged-on to the instant messaging program reads task description 720 and responds accordingly. A responding member of workgroup community 780 may accept or reject task 720 by placing a “mark” in an appropriate box. If the responding member of workgroup 780 accepts task 720, then I CAN box 730 is marked. If the responding member of workgroup 780 rejects task 720, then I CANNOT box 740 is marked. If I CANNOT box 740 is selected by the responding member of workgroup 780, then text box 750 is used to provide the reason for rejecting task 720. Reasons for rejecting task 720 may be, for example, currently working on other major projects, leaving on vacation, not in my area of expertise, et cetera.

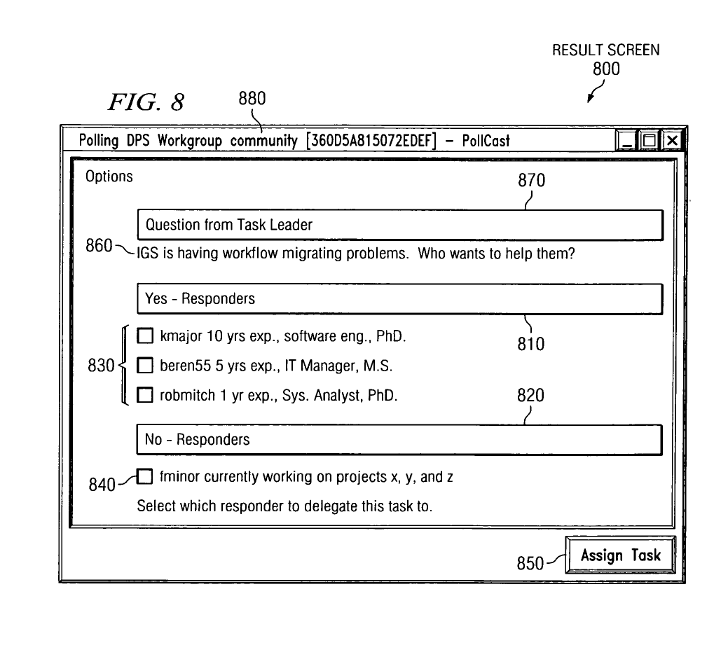

When the responding member of workgroup 780 has completed workgroup task response page 700, he or she hits respond button 770. All responses from workgroup 780 for task description 720 are sent to task leader 710 for review and selection of a task owner. For example, users of instant messaging clients 402 and 403 send responses to instant messaging client 401 via instant messaging server process 404 in FIG. 4. Optionally, the responding member of workgroup 780 may view the results of the task delegation broadcast message prior to submitting workgroup task response page 700 by hitting view response button 760. The results of workgroup community 780 responses are discussed in the description of FIG. 8 below.

Turning now to FIG. 8, an example display is shown illustrating a result screen that lists task respondents in accordance with a preferred embodiment of the present invention. Result screen 800 is employed to provide task leader 870 with the responses from workgroup community 880 to task description 860. Responders from workgroup community 880 may be listed under different categories, such as, for example, Yes Responders 810 or No Responders 820. Workgroup responders 830 indicated that they accept task 860. For example, a member of workgroup community 780 marked I CAN box 730 prior to hitting respond button 770 on workgroup task response page 700 to indicate that he or she can accept task 720 in FIG. 7. Consequently, workgroup responders 830 are listed under Yes Responders 810.

Workgroup responders 830 may have their names listed alphabetically, chronologically in the order of response, by seniority, or in any other manner deemed suitable for the utilization of the system of the present invention. In addition, a brief biographical sketch of workgroup responders 830 may be provided. The biographical sketch of the respective responder may include, for example, but is not restricted to, years of experience, years of employment with the enterprise, area of expertise, and college degree and major. The biographical sketch may be used for the purpose of determining the best person for task 860 from among workgroup responders 830.

Workgroup responder 840, listed under No Responders 820, indicated that he or she cannot accept task 860. For example, a member of workgroup community 780 marked I CANNOT box 740 on workgroup task response page 700 to indicate that he or she cannot accept task 720 in FIG. 7. In addition to the name of workgroup responder 840 being listed, the reason for rejecting task 860 is posted as well. For example, reason for rejecting task 720 is input into text box 750 on workgroup task response page 700 in FIG. 7. Further, biographical information for workgroup responder 840 also may be included.

Task leader 870, after reviewing result screen 800, selects a listed member of workgroup 880 by marking the appropriate box associated with the name of the selected member. A marked box on result screen 800 indicates that the respective member of workgroup community 880 is now a task owner. It should be noted that task leader 870 may select one, more than one, or all members of workgroup 880 as a task owner. Also, it should be noted that task leader 870 may select a responder from either Yes Responders 810 or No Responders 820 for task 860.

Subsequent to selecting and marking the task owner on result screen 800, task leader 870 hits assign task button 850. After the task has been assigned and delegated, a window appears on the task owner's display indicating that he or she is the task owner. In addition to the task owner receiving the task assignment, if task leader 870 set a preference on the leader task initiation page to open a chat with the task owner, a dialog window appears between the task owner and task leader 870 for the purpose of discussing task 860. For example, open chat with task owner box 640 is marked on leader task initiation page 600 by the task leader in FIG. 6.

Alternatively, task 860 may be automatically delegated to a member of workgroup community 880, if task leader 870 marks the automatically delegate preference box on the leader task initiation page as discussed in the description of FIG. 6 above. For example, the task leader marks on leader task initiation page 600 automatically delegate preference box 630 in FIG. 6. After task 860 is automatically delegated to a member of workgroup community 880, a window automatically appears on the task owner's display indicating that he or she is the task owner.

Also, as discussed previously, if task leader 870 set the preference on the leader task initiation page to open a chat with the task owner after auto delegation, a dialog window appears between the task owner and task leader 870. If the responder from workgroup community 880 is not automatically selected for the task, then result screen 800 appears on the responder's display showing the automatically selected task owner. Additionally, the process of an embodiment of the present invention may, for example, utilize a database, such as storage 106 in FIG. 1, to store and track each assigned task and workgroup members delegated to the respective tasks.

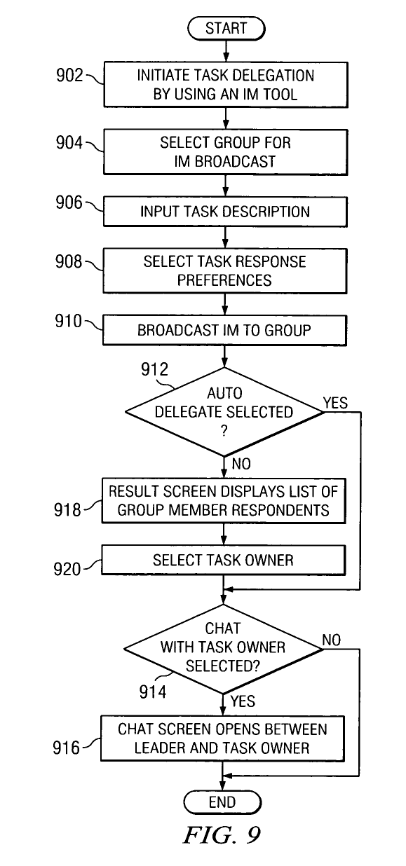

With reference now to FIG. 9, a flowchart is depicted of a process for using a workgroup leader instant messaging device in accordance with a preferred embodiment of the present invention. The process begins when a task leader initiates delegation of a task by using an instant messaging tool (step 902). For example, a task leader uses leader task initiation page 600 in FIG. 6 to initiate task delegation. The task leader selects a workgroup community from a contact list for broadcast of the task delegation message (step 904). For example, a task leader selects names of individuals, workgroups, or a combination of both from contact list 508 in FIG. 5.

After selecting the workgroup community in step 904, the task leader inputs the task description (step 906). For example, the task leader inputs the task description in text box 620 in FIG. 6. Then the task leader may select task response preferences (step 908), such as, for example, selecting automatically delegate box 630 and/or open chat with task owner box 640 in FIG. 6.

Subsequent to selecting a workgroup community to send the broadcast message, inputting the task description, and determining response preferences in steps 904, 906, and 908, the task delegation message is broadcast to the workgroup community (step 910). After broadcast of the task delegation message to the workgroup community in step 910, a determination is made as to whether the task leader selected the auto delegation preference (step 912). The task leader by setting the auto delegation preference makes the first responder to the task delegation message a task owner. Alternatively, auto delegation may be by selecting a best match based on biographical information listed with each responding workgroup member. Consequently, no decision by the task leader needs to be made as to which member of the workgroup will be the task owner.

If the auto delegation response preference was not set by the task leader, no output of step 912, then a result screen is displayed to the task leader listing the responding workgroup members (step 918). In addition to the names of the responding workgroup members being listed on the result screen, biographical and skill level information of the respective workgroup member may be posted for the purpose of aiding the task leader in determining who is best qualified for the task. Further, if the responding workgroup member inputs a reason for task unavailability, then the text of the reason may be posted with the name of the respective workgroup member as well.

Subsequent to the result screen displaying the names of responding workgroup members in step 918, the task leader selects a task owner from the list of workgroup responders (step 920). After a task owner is selected in step 920, a determination is made as to whether the task leader set the chat with the task owner response preference (step 914). If the task leader did not set the chat with task owner response preference, no output of step 914, then the process terminates thereafter. If the task leader set the chat with task owner response preference, yes output of step 914, then a chat screen opens between the task owner and the task leader (step 916). The process terminates thereafter.

Returning now to step 912, if the task leader set the auto delegate response preference, yes output of step 912, then the process proceeds to step 914 as described above.

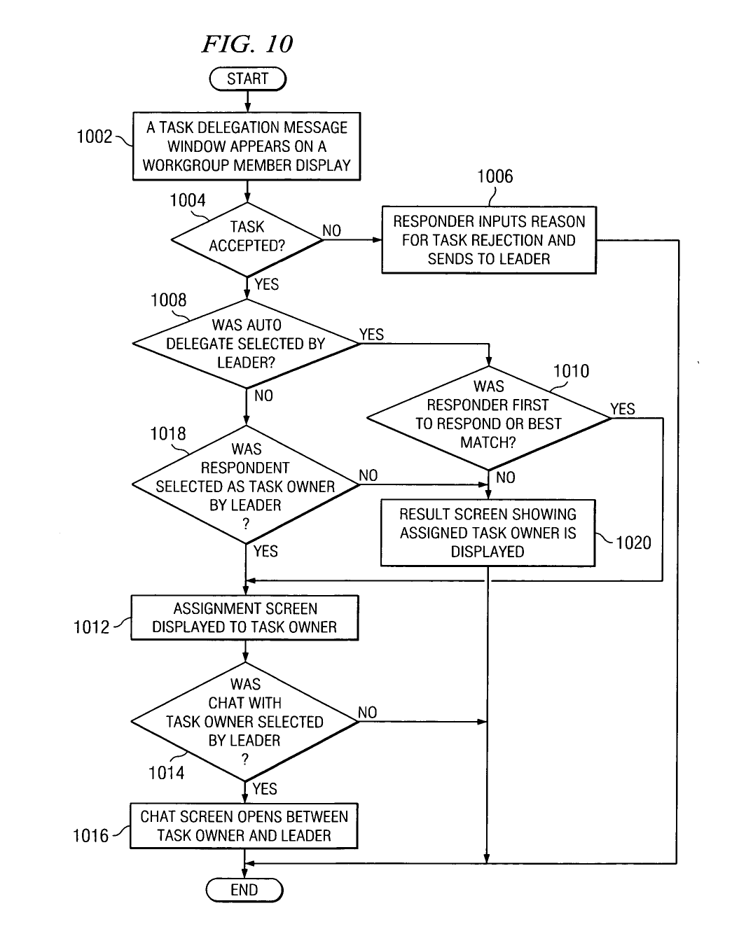

Referring now to FIG. 10, a flowchart of a process for utilizing a workgroup member instant messaging device is shown in accordance with a preferred embodiment of the present invention. The process begins when a task delegation message window appears on a workgroup member display that is logged-on to an instant messaging application (step 1002). For example, message 502 appears in dialog window 504 on instant messaging application 500 in FIG. 5. Next, a determination is made as to whether the task is accepted by the workgroup member (step 1004). For example, in FIG. 7, a member of workgroup 780 marks I CAN box 730 on workgroup task response page 700 to indicate that he or she may accept the task.

If the task is not accepted by the workgroup member, no output of step 1004, then the responding workgroup member inputs the reason for rejecting the task and transmits the rejection message to the task leader (step 1006). For example, a member of workgroup 780 marks I CANNOT box 740 on workgroup task response page 700 of FIG. 7 and inputs the reason for rejecting the task into text box 750 to indicate that he or she cannot accept the task. The process terminates thereafter.

If the task was accepted by the workgroup member, yes output of step 1004, then a determination is made as to whether the task leader set the auto delegate response preference (step 1008). For example, the task leader marks automatically delegate box 630 on leader task initiation page 600 in FIG. 6 for the purpose of setting that particular response preference. If the auto delegate response preference is not set by the task leader, no output of step 1008, then a determination is made as to whether the responding workgroup member is selected by the task leader to be the task owner (step 1018). For example, task leader 870 marks workgroup member responder box 840 in order to delegate task 860 to that respective workgroup member in FIG. 8. If the responding workgroup member is not selected by the task leader to be the task owner, no output of step 1018, then a result screen, such as, for example, result screen 800 in FIG. 8, displays the name of the workgroup member delegated with the task (step 1020) and the process terminates thereafter.

Returning now to step 1008, if the auto delegate response preference is set by the task leader, yes output of step 1008, then a determination is made as to whether the responding workgroup member is the first to respond to the task delegation message (step 1010). Alternatively, a determination may be made as to whether the responding workgroup member is the best match based upon the responding workgroup member's biographical information. If the responding workgroup member is not the first to respond to the task delegation message, no output of step 1010, then the process proceeds to step 1020. If the responding workgroup member is the first to respond to the task delegation message, yes output of step 1010, then an assignment screen is displayed to the responding workgroup member stating that he or she is the task owner (step 1012).

After the assignment screen is displayed to the responding workgroup member in step 1012, then a determination is made as to whether the task leader set a chat with the task owner response preference (step 1014). For example, the task leader marks open chat with task owner box 640 on leader task initiation page 600 in FIG. 6 in order to set that particular response preference. If the chat with the task owner response preference is not set by the task leader, no output of step 1014, then the process terminates thereafter. If the chat with the task owner response preference is set by the task leader, yes output of step 1014, then a chat screen opens between the task owner and the task leader to discuss the task (step 1016). The process terminates thereafter.

Returning now to step 1018, if the responding workgroup member is selected by the task leader to be the task owner, yes output of step 1018, then the process proceeds to step 1012.

Thus, the present invention provides a method, apparatus, and computer program product for the fast and effective delegation of a task by using an instant messaging system. A task leader broadcasts a task delegation message via instant messaging to members in a workgroup. The name or some other type of workgroup member identification (e.g., employee ID number, employee ID photo, etc.) for each responding workgroup member to the task delegation message is posted on a result screen. In addition, a biographical sketch of each responding workgroup member may be displayed, along with the respective name or other type of workgroup member identification. Also, on the workgroup task response page a text box may be provided in order for a responding workgroup member, which indicated that he or she was unable to accept the task, to input a reason for the task rejection. Subsequently, the task leader delegates or assigns the task to one or more of the responding workgroup members. Alternatively, the task may be automatically delegated if the task leader sets such a response preference on the leader task initiation page.

Each delegated task may be tracked by storing information regarding the task and the workgroup members assigned to the task in a task delegation database. In the task delegation database, the stored information may be integrated into and referenced by the instant messaging system to allow for determining which tasks have been delegated and to whom.

A benefit of the present invention is that task delegation time is greatly reduced by not requiring a task leader to schedule a workgroup meeting to discuss the task and its subsequent delegation to a member of the workgroup. In fact, no discussion is required between the task leader and the workgroup because the task description is provided in the initial task delegation broadcast message. Therefore, the task leader almost immediately upon receipt may send out the task delegation message to workgroup members. In response, workgroup members merely need to indicate on a response page whether they are available to perform the task. Thus, the present invention provides a system for almost instantaneous task delegation, with real time feedback and agreement from workgroup members. In addition, the present invention provides a system where workgroup members have an option to accept the task assignment.

Another benefit of the present invention is that a brief biographical sketch is provided with the respective name of each responsive workgroup member that indicated that he or she is available for the task assignment. This feature provides valuable information in selecting the best workgroup member for the task. Also, the task leader can quickly see on a result screen who is and who is not available for task delegation, and why. Further, each delegated task and task owner is tracked using a database for the purpose of optimally utilizing human resources.

It is important to note that while embodiments of the present invention have been described in the context of a fully functioning data processing system, those of ordinary skill in the art will appreciate that the processes of embodiments of the present invention are capable of being distributed in the form of instructions or computer readable program code embodied in a computer readable medium and a variety of forms and that embodiments of the present invention applies equally regardless of the particular type of signal bearing media actually used to carry out the distribution. The computer readable program code comprises instructions and/or data. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for delegation of a task via an instant messaging system, the method comprising:
sending an instant message broadcast to members in a workgroup;
receiving one or more responses to the instant message broadcast from members in the workgroup;
listing each responding workgroup member on a result screen, wherein each responding workgroup member includes biographical information;
delegating the task to at least one of the responding workgroup members;
storing the delegated task and the responding workgroup members to whom the task was delegated to form stored task delegation information; and
tracking the delegated task using the stored task information.

2. The method of claim 1, wherein the instant message broadcast is a task delegation message.

3. The method of claim 1, wherein the sending and delegating steps are performed by a task leader.

4. The method of claim 1, wherein the workgroup is a predetermined workgroup.

5. The method of claim 1, wherein the result screen comprises:
a yes responder group and a no responder group.

6. The method of claim 1, wherein the tracking step is performed using a task delegation database.

7. The method of claim 5, wherein the no responder group comprises:
a reason for task rejection by a no responding workgroup member.

8. The method of claim 1, wherein the delegating step comprises:
displaying a task owner name to the responding workgroup members.

9. The method of claim 1, wherein the delegating step is performed automatically by selecting a best match using the biographical information of each responding workgroup member.

10. The method of claim 9, wherein automatic delegation is accomplished by setting a response preference.

11. A data processing system comprising:
a bus system;
a memory connected to the bus system, wherein the memory includes a set of instructions; and
a processing unit connected to the bus system, wherein the processing unit executes the set of instructions to send an instant message broadcast to members in a workgroup, receive one or more responses to the instant message broadcast from members in the workgroup, list each responding workgroup member on a result screen, wherein each responding workgroup member includes biographical information, delegate the task to at least one of the responding workgroup members, store the delegated task and the responding workgroup members to whom the task was delegated to form stored task delegation information, and track the delegated task using the stored task information.

12. The data processing system of claim 11, wherein the instant message broadcast is a task delegation message.

13. The data processing system of claim 11, wherein the workgroup is a predetermined workgroup.

14. The data processing system of claim 11, wherein the result screen comprises:
a yes responder group and a no responder group.

15. The data processing system of claim 11, wherein the processor executes further instructions to display a task owner name to the responding workgroup members.

16. A computer program product for delegation of a task via an instant messaging system, the computer program product comprising:
a computer readable medium having computer readable program code embodied therein, the computer readable medium comprising:
computer readable program code configured to send an instant message broadcast to members in a workgroup;
computer readable program code configured to receive one or more responses to the instant message broadcast from members in the workgroup;
computer readable program code configured to list each responding workgroup member on a result screen, wherein each responding workgroup member includes biographical information;
computer readable program code configured to delegate the task to at least one of the responding workgroup members;
computer readable program code configured to store the delegated task and the responding workgroup members to whom the task was delegated to form stored task delegation information; and
computer readable program code configured to track the delegated task using the stored task information.

17. The computer program product as recited in claim 16, wherein the computer readable program code configured to track each responding workgroup member delegated the task is performed using a task delegation database.

18. The computer program product as recited in claim 16, wherein the computer readable program code configured to list each responding workgroup member on a result screen comprises:
computer readable program code configured to display a reason for task rejection by a no responding workgroup member.

19. The computer program product as recited in claim 16, wherein the computer readable program code configured to delegate the task to at least one of the responding workgroup members is performed automatically by selecting a best match using the biographical information of each responding workgroup member.

20. The computer program product as recited in claim 19, wherein the computer readable program code configured to delegate the task to at least one of the responding workgroup members is performed automatically by setting a response preference.
